(19) United States
(12) Patent Application Publication
(10) Pub. No.: US 2025/0322108 A1
(43) Pub. Date: Oct. 16, 2025

(54) CIRCUIT DESIGN VERIFICATION TO PREVENT PLASMA INDUCED DAMAGE

(71) Applicant: Siemens Industry Software Inc., Plano, TX (US)

(72) Inventor: Derong Yan, LAKE OSWEGO, OR (US)

(73) Assignee: Siemens Industry Software Inc., Plano, TX (US)

(21) Appl. No.: 18/635,458

(22) Filed: Apr. 15, 2024

(51) Int. Cl. G06F 21/88; G06F 30/398

(52) U.S. Cl. CPC G06F 21/88; G06F 30/398

(57) ABSTRACT

Methods for circuit design verification and corresponding systems and computer-readable mediums. A method includes receiving a plasma induced damage (PID) group defining a plurality of metal layers and having at least one risk connection comprising a plurality of risk links, and at least one corresponding protection connection comprising a plurality of protection links. The method includes identifying a lowest risk protection layer as a lowest of plurality of metal layers at which any of the risk links is established. The method includes determining whether a connection is established for all of the protection links at the lowest risk protection layer. The method includes, when it is determined that a connection is established for all of the protection links at the lowest risk protection layer, then returning a PASS result.

### TECHNICAL FIELD

The present disclosure is directed, in general, to circuit design verification and more particularly verification of circuit designs in plasma etch manufacturing.

### BACKGROUND OF THE DISCLOSURE

Modern wafer processing uses “plasma etch” (or “dry etch”) using an ionized/reactive gas. This allows fine control of pattern and also allows a number of chemical reactions that are not possible in traditional (wet) etch.

However, plasma etching may introduce several unwanted effects. One of these is the charging damage, which refers to the unintended high-field stressing of the gate-oxide in MOSFET during plasma processing. The stress voltage that develops across the gate and substrate of a MOSFET during plasma processing can arise from a number of sources, including non-uniform distribution of plasma potential across the wafer, charging filtering (shading) due to microscopic topography on the wafer, or AC effects due to the nature of RF discharge that sustain the plasma.

Some systems use design rules to check and detect whether plasma induced damage (PID) is likely in manufacturing from a specific circuit layout design. Current methods, however, are inefficient for specific verifications, including checking risk connections versus protection connections. Improved systems are desirable.

### SUMMARY OF THE DISCLOSURE

Various disclosed embodiments include methods for circuit design verification and corresponding systems and computer-readable mediums. A method includes receiving a plasma induced damage (PID) group defining a plurality of metal layers and having at least one risk connection comprising a plurality of risk links, and at least one corresponding protection connection comprising a plurality of protection links. The method includes identifying a lowest risk protection layer as a lowest of plurality of metal layers at which any of the risk links is established. The method includes determining whether a connection is established for all of the protection links at the lowest risk protection layer. The method includes, when it is determined that a connection is established for all of the protection links at the lowest risk protection layer, then returning a PASS result.

In various embodiments, identifying a lowest risk protection layer comprises identifying a lowest risk protection layer among each of the plurality of risk links by analyzing the plurality metal layers to determine whether connection is established for each of the risk links. In various embodiments, the system only analyzes metal layers for each risk link that are below the metal layers of the plurality of metal layers in which a connection has already been established for one of the risk links. In various embodiments, if a connection is established for a risk link at a lowest one of the metal layers, then the lowest one of the metal layers is identified as the lowest risk protection layer and the system stops analyzing whether a connection is established for each of the risk links.

In various embodiments, determining whether a connection is established for all of the protection links at the lowest risk protection layer includes analyzing each of the protection links to determine whether a connection is established at the lowest risk protection layer, and not analyzing the protection links at any other metal layer.

Various embodiments also include when it is determined that a connection is not established at every one of the protection links at the lowest risk protection layer, then returning a FAIL result. In various embodiments, the system stops determining whether a connection is established for all of the protection links at the lowest risk protection layer when the system determines that a connection is not established for any one of the protection links at the lowest risk protection layer. Various embodiments also include determining a PASS or FAIL of the PID group based on determining whether a connection is established for all of the protection links at the lowest risk protection layer. Various embodiments also include modifying a circuit design layout based on determining that a connection is not established at any one of the protection links at the lowest risk protection layer (or, equivalently, at every one of the protection links at the lowest risk protection layer).

Disclosed embodiments also include a computer system comprising a processor and an accessible memory, configured to perform processes as disclosed herein, and a non-transitory computer-readable medium encoded with executable instructions that, when executed, cause one or more computer systems to perform processes as disclosed herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIGS. 1 and 2 illustrate aspects of a computer system that can be used to implement various embodiments disclosed herein;

FIG. 3 illustrates an example of a risk connection and a protection connection in accordance with disclosed embodiments;

FIG. 4 illustrates a diagram of a generic PID problem in accordance with disclosed embodiments; and

FIG. 5 illustrates a flowchart of a process in accordance with disclosed embodiments.

### DETAILED DESCRIPTION

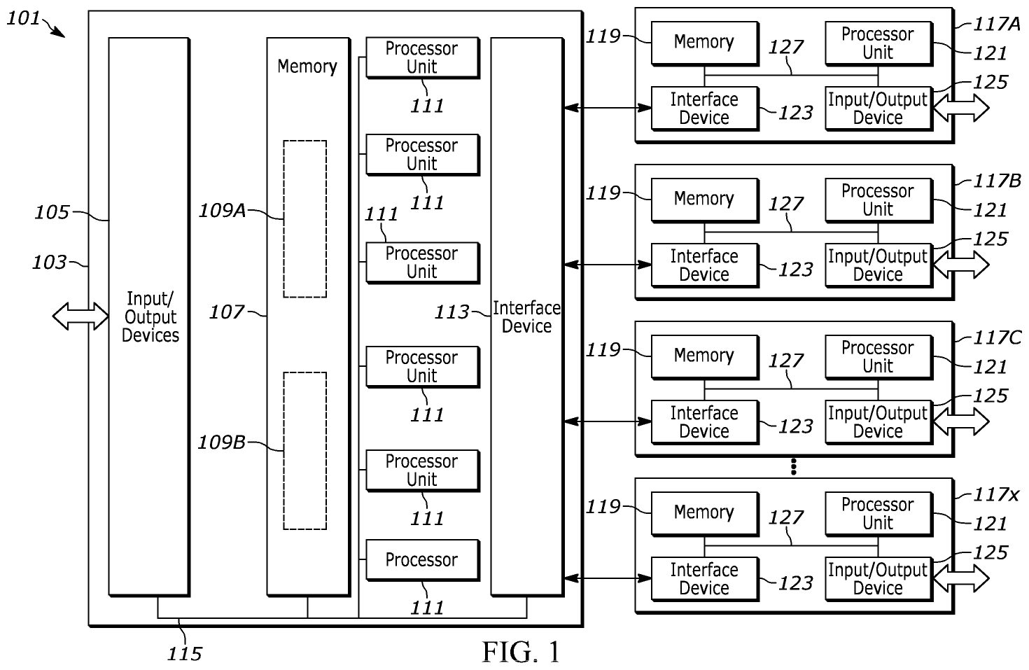

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Some PID design rules check if a protection connection is established before a risk connection is established in an integrated circuit layout design based on the connecting sequence of metal stack during silicon manufacturing process. A risk connection can be a connection between the Source/Drain pin of a NMOS device and the Gate pin of a NMOS device residing in a different P-type well. A protection connection, by contrast, can be a connection between the two P-type wells in which the two NMOS devices reside. If the protection connection is established no later than the risk connection is established per the connecting sequence of metal stack, the risk connection is considered as safe; otherwise, the risk connection is flagged as a violation. That is, the protection connection must be manufactured no later than the same layer as the risk connection to be safe, but can be manufactured at a prior, lower layer in the metal stack and still be able to protect the risk connection. For purposes of this discussion, the layers in the metal stack are assumed to be manufactured in lower-to-higher order, so a lower-numbered layer indicates manufacture before a higher-numbered layer, and the lower-numbered layer may be referred to as “below” or “under” the higher-numbered layer, but of course the actual orientation at or after manufacture may differ.

In a generic PID problem, the “risk connection” may include a group of individual connections and, in such cases, the lowest metal layer at which at least one individual connection is established is considered as the metal layer at which the “risk connection” is established. The “protection connection” may include one or more groups of individual connections and, in such cases, the lowest metal layer at which all individual connections in a group are established is considered as the metal layer at which this group of individual connections is established.

In a PID design rule checking flow, each individual connection is analyzed by an Electronic Design Automation (EDA) tool, such as the Calibre PERC software of Siemens EDA, to determine the lowest metal layer at which the connection is established. A “risk connection” plus its corresponding “protection connection” is referred to as a PID group. There may be millions of PID groups involved in a PID design rule check. A larger number of PID groups, a higher number of individual connections contained by each PID group, or more metal layers in the metal stack used in the analysis all result in longer runtime for a PID design rule check.

Disclosed embodiments improve upon other techniques by employing a process that uses real-time results to eliminate unnecessary analyses on subsequent individual connections, and therefore to achieve faster and more efficient runtimes for PID design rule checks. Disclosed embodiments can use the analysis results of the individual connections which have already been analyzed to eliminate unnecessary check and more quickly determine whether individual risk connections, and all risk connections, are properly protected against PID damage.

### Illustrative Operating Environment

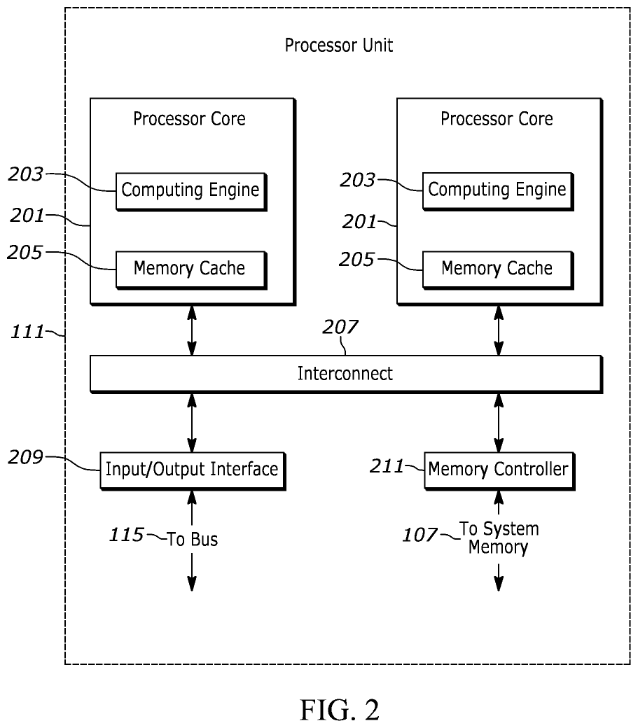

FIGS. 1 and 2 illustrate aspects of a computer system that can be used to implement various embodiments disclosed herein. The execution of various processes described herein may be implemented using computer-executable software instructions executed by one or more programmable computing devices. Because these processes may be implemented using software instructions, the components and operation of a generic programmable computer system on which various embodiments of these processes may be employed will first be described. Further, because of the complexity of some electronic design and testing processes and the large size of many circuit designs, various electronic design and testing tools are configured to operate on a computing system capable of simultaneously running multiple processing threads. The components and operation of a computer system having a host or master computer and one or more remote or slave computers therefore will be described with reference to FIG. 1. This operating environment is only one example of a suitable operating environment, however, and is not intended to suggest any limitation as to the scope of use or functionality of any implementations of the invention.

In FIG. 1, the computer system 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other non-transitory storage medium that can be used to store desired information. As used herein, the term “non-transitory” refers to the ability to store information for subsequent retrieval at a desired time, as opposed to propagating electromagnetic signals.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

With some implementations of the invention, the master computer 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only and is not intended to be limiting. It also should be appreciated that, with some implementations, a multi-core processor unit 111 can be used in lieu of multiple, separate processor units 111. For example, rather than employing six separate processor units 111, an alternate implementation of the computing system 101 may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the slave computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the slave computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 117 may include a memory 119, a processor unit 121, an interface device 123, and, optionally, one or more input/output devices 125 connected together by a system bus 127. As with the master computer 103, the optional input/output devices 125 for the slave computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel®. Pentium®. or Xeon™ microprocessors, Advanced Micro Devices Athlon™ microprocessors or Motorola 68K/Coldfire®. microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. The memory 119 then may be implemented using any combination of the computer readable media discussed above. Like the interface device 113, the interface devices 123 allow the slave computers 117 to communicate with the master computer 103 over the communication interface.

In the illustrated example, the master computer 103 is a multi-processor unit computer with multiple processor units 111, while each slave computer 117 has a single processor unit 121. It should be noted, however, that alternate implementations of the technology may employ a master computer having single processor unit 111. Further, one or more of the slave computers 117 may have multiple processor units 121, depending upon their intended use, as previously discussed. Also, while only a single interface device 113 or 123 is illustrated for both the master computer 103 and the slave computers, it should be noted that, with alternate embodiments of the invention, either the computer 103, one or more of the slave computers 117, or some combination of both may use two or more different interface devices 113 or 123 for communicating over multiple communication interfaces.

With various examples of the computer system 101, the master computer 103 may be connected to one or more external data storage devices. These external data storage devices may be implemented using any combination of non-transitory computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the computer system 101, one or more of the slave computers 117 may alternately or additions be connected to one or more external non-transitory data storage devices. Typically, these external non-transitory data storage devices will include data storage devices that also are connected to the master computer 103, but they also may be different from any data storage devices accessible by the master computer 103.

It also should be appreciated that the description of the computer system 101 illustrated in FIG. 1 and FIG. 2 is provided as an example only, and is not intended to suggest any limitation as to the scope of use or functionality of various embodiments of the invention.

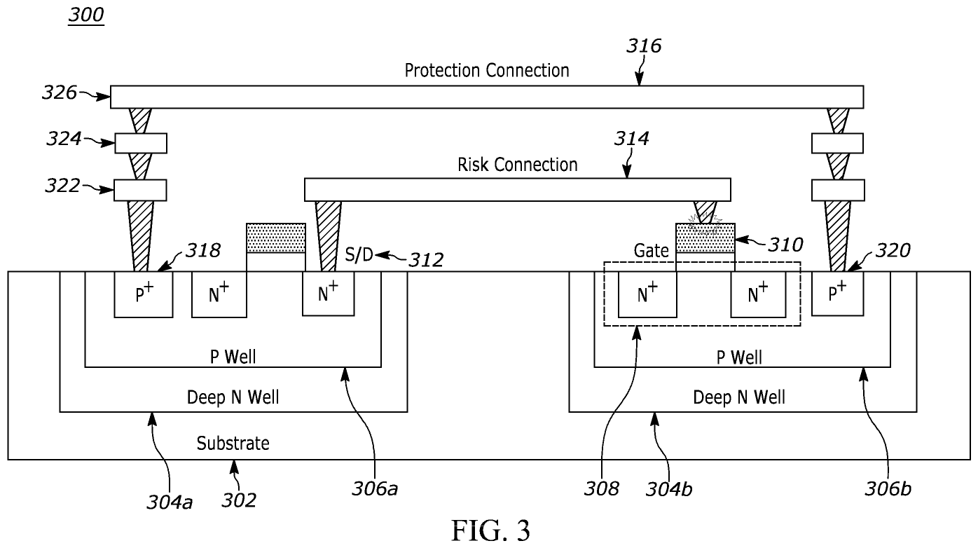

FIG. 3 illustrates an example of a risk connection and a protection connection in accordance with disclosed embodiments. In this example of a device 300, a semiconductor substrate has isolated deep N wells 304a and 304b, which in turn have respective P wells 306a and 306b. In the P wells, in this example, are various P+ and N+ doped regions forming various semiconductor elements. As relevant for this illustration, the elements at 308 form an NMOS NPN transistor in P well 306b with a gate 310 that is driven by the source/drain connection of a device in the isolated P well 306a.

In this example, consider that there are multiple metal layers, including (lowest to highest) M1 322, M2 324, and M3 326.

The metal layer M1 322 that connects the driver 312 and the gate 310 is risk connection 314. To protect against PID damage during manufacture, a metal layer M3 326 connecting P+ region 318 in P well 306a with P+ region 320 in P well 306b is used as a protection connection 316. However, in this example, protection connection 316 is not effective because it is at a higher level than risk connection 314 and therefore was formed after risk connection 314. As described above, to be effective, the protection connection must be formed in the same or a lower metal layer than the risk connection. PID design rules can be used to check for and flag as violations when a risk connection 314 between driver 312 and receiver 310 is established before corresponding protection connection 316 between the two isolated P-type wells 306a/306b is established.

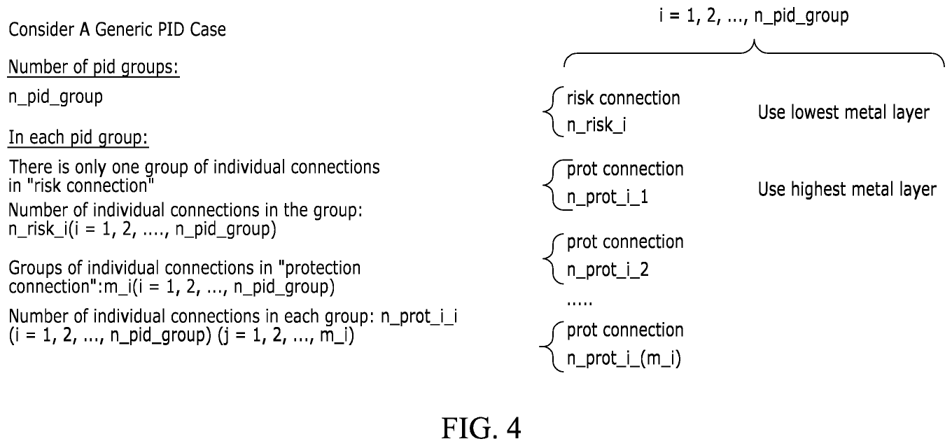

FIG. 4 illustrates a diagram of a generic PID problem in accordance with disclosed embodiments. As illustrated in this example, there are a total of n_pid_group PID groups for analysis. In each PID group, the “risk connection” includes a group of n_risk_i individual connections, where i=1, 2, . . . , n_pid_group; the “protection connection” consists of m_i groups of individual connections, where i=1, 2, . . . , n_pid_group, and each group has n_prot_i_j individual connections, where i=1, 2, . . . , n_pid_group, and j=1, 2, . . . , m_i.

Some processes can analyze all individual connections in parallel, regardless whether they are from “risk connection” or “protection connection.” In doing so, an individual connection is analyzed at each metal layer in the metal stack, starting from the lowest metal layer, to determine whether the connection is established at the metal layer; and if connection is found established at a metal layer, then the analysis is considered as done for the individual connection. This approach is less than ideal, since every connection must be analyzed at every metal layer.

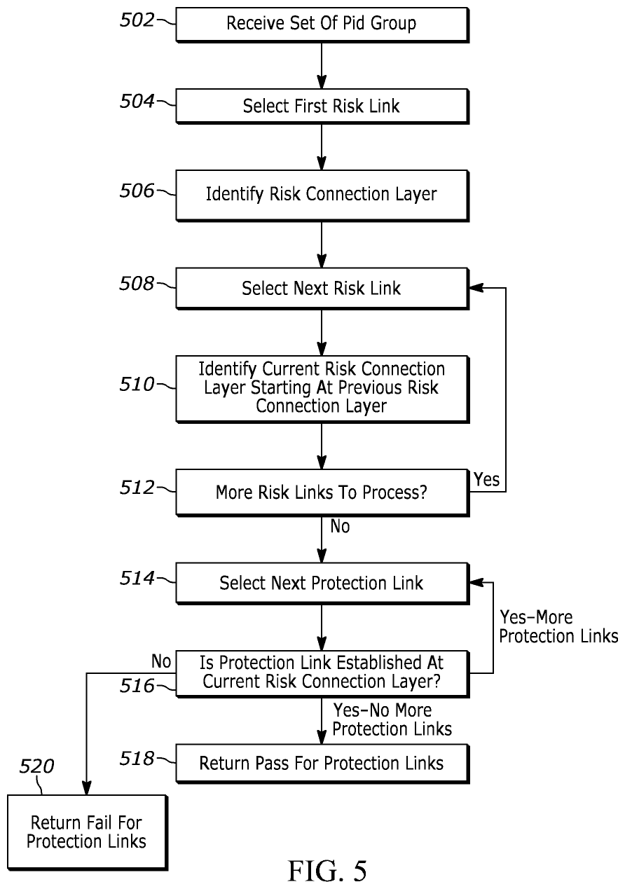

Disclosed embodiments include improved processes that are more efficient and eliminate unnecessary verifications. Using the same generic PID problem as shown in FIG. 4 for purposes of illustration, FIG. 5 illustrates a process in accordance with disclosed embodiments, which can be performed by one or more computer systems 101 (generically referred to as the “system,” below).

At 502, the system receives a set of PID groups (or at least one PID group) to be tested. The groups can be received as part of a circuit design layout. “Receiving,” as used herein, can include loading from storage, receiving from another device or process, receiving via an interaction with a user, and otherwise. For purposes of this description, assume that the PID groups describe a metal stack that includes metal layers M1 (lowest/first metal layer) through M15 and MTOP (last/top layer for aluminum pad connections). The set of PID groups can include all of the individual connections for each of the PID groups. Each connection can be indicated as belonging to a risk connection or a protection connection. An individual connection in a risk connection will be referred to herein as a “risk link,” and an individual connection in a protection connection will be referred to herein as a “protection link.”

The system can process all of the PID groups in parallel. Let n_pid_group represent the total number of parallel jobs for analysis. The description below is as applied to a single PID group. In the simplest case, at 502, the system receives a PID group defining a plurality of metal layers and having at least one risk connection, with at least one risk link, and at least one corresponding protection connection, with at least one protection link. The risk link(s) and protection link(s) are defined within the metal layers. In most practical cases, at 502, the system receives a PID group defining a plurality of metal layers and having at least one risk connection with a plurality of risk links, and at least one corresponding protection connection with a plurality of protection links.

At 504, in each PID group, the system selects the first risk link of a risk connection.

At 506, the system analyzes the first risk link at each layer, beginning at the lowest metal layer (e.g., M1, M2, M3, . . . ) to identify the first (hence, lowest) metal layer at which the first risk link exists (the “risk connection layer”). For purposes of illustration, assume the connection is found established at M5, making metal layer M5 the lowest risk connection layer.

At 508, if there are more risk links (i.e., n_risk_i>1), the system selects the next risk link of the risk connection.

At 510, the system identifies the lowest risk connection layer for the risk connection by analyzing each risk link until either the lowest metal layer (M1) is identified as the lowest risk connection layer or all risk links have been analyzed to identify the lowest risk connection layer at which any risk link is found established.

As part of 510, the system analyzes the next risk link at each metal layer, starting from the metal layer below the current lowest risk connection layer, and moving to each lower metal layer successively. In this example, where the current lowest risk connection layer is M5, the metal layer below the current lowest risk connection layer is M4, so the system analyzes the next risk link starting at M4. Since a risk connection is already established at the current lowest risk connection layer M5, there is no need to test either M5 or any higher metal layer.

If the risk link is found established at M4, then the system analyzes the next lower metal layer M3 and repeats until the lowest metal layer M1 has been tried (in such case, the system moves on to the next risk link, returning from 512 to 508). The lowest metal layer at which the risk link is established becomes the new risk connection layer. A metal layer is considered as the lowest metal layer at which the risk link is established only if at the next lower metal layer the risk link is found to be not established, unless the metal layer is the lowest metal layer M1.

If the risk link is not found established at M4, then the system is finished analyzing this risk link and moves to the next risk link (returning from 512 to 508). There is no need to do analysis at M5 or above. That is, because the significant risk connection layer is the lowest layer at which at least one risk link is established and this lowest layer is considered as the metal layer at which the “risk connection” is established, the process at 510 is to identify whether the current lowest risk connection layer is the lowest risk connection layer of all the risk links of the risk connection in the PID group.

At 512, the system determines whether it is necessary to process more risk links, based on whether the current lowest risk connection layer is above the lowest metal layer (>M1) and/or the current risk link is not established, and if so, returns to 508. 508 and 510 are thus repeated to cover all individual risk links in “risk connection”, each time using the next metal layer below the current risk connection layer as the starting point and searching lower in the metal stack. When the current risk connection layer is ever found to be the lowest metal layer (M1), then there is no need to process any risk links of this risk connection any further, since the lowest possible risk connection layer is already identified.

When all risk links of the risk connection have been processed, or the current lowest risk connection layer is M1 so the remaining risk links do not need to be processed, the system moves to 514. 506-512 together therefore identify a lowest risk protection layer for the risk connection as a lowest of plurality of metal layers at which any of the risk links is established.

After finishing analyzing all individual risk links of the risk connection and establishing the lowest risk connection layer (the final risk connection layer for that risk connection), the system can then analyze the corresponding protection connection. Assume, for the discussion below, that the lowest risk protection layer is established at M3.

At 514, the system selects the first (or next) protection link in the protection connection.

At 516, the system analyzes the selected protection link in the protection connection to determine whether it is established at the lowest risk protection layer. The system can process all groups of protection links in parallel (i.e., each group of individual connections is considered as a single job which is submitted to a remote machine for analysis) or in serial. In this example process, the system analyzes the selected protection link in the protection connection to determine whether it is established at M3, the lowest layer at which any risk links in the risk connection are established.

If, at 516, the system determines that the selected protection link is established at the current/final risk protection layer, the system returns to 514 to select the next link (noting again that some or all of these checks can be performed in parallel). There is no need to verify each protection link at any other level, and the system preferably does not do so-it is unnecessary to determine whether the protection connection was established before the risk connection, at a lower risk protection layer, and it is insufficient if the protection connection was established after the risk connection, at a higher risk protection layer.

514-516 together therefore determine whether a connection is established for all of the protection links at the lowest risk protection layer.

If, at 516, the system determines that the selected protection link is not established at the current/final risk protection layer, then the system returns a FAIL for that set of protection links at 520.

At 518, once all protection links at the current risk protection layer have been analyzed, if all of them show that the protection link is established at the current risk protection layer, the system returns a PASS for that set of protection links of the protection connection.

At 520, if at any time any of the protection links are not established at the current risk protection layer, the system returns a FAIL for that set of protection links.

At this point the system can also determine a PASS or FAIL of the PID group based on the protection connection results and any PID design rules. The system can thereafter modify the circuit design layout based on the returned results to correct any failure, and a physical circuit can be manufactured according to the circuit design layout.

A process as disclosed herein has several significant differences from and advantages over other approaches. For example, the system can process each risk link in a risk connection first, to establish the only risk connection layer that is significant for testing the protection connection.

Processes as disclosed herein can process multiple risk links in a risk connection serially and use the results of each step to reduce the number of metal layers that must be tested for each risk link in a risk connection in each subsequent iteration, avoiding unnecessary analysis.

Processes as disclosed herein can limit analysis for protection links to only the risk connection metal layer, eliminating the need to test any other layer for the protection connection. Also, processes as disclosed herein can cease testing protection links for a protection connection as soon as a single protection link fails to be established at the risk connection level.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all computer systems suitable for use with the present disclosure is not being depicted or described herein. Instead, only so much of a computer system as is unique to the present disclosure or necessary for an understanding of the present disclosure is depicted and described. The remainder of the construction and operation of computer system 101 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

What is claimed is:

1. A method for circuit design verification, the method performed by a computer system and comprising:
receiving a plasma induced damage (PID) group defining a plurality of metal layers and having at least one risk connection comprising a plurality of risk links, and at least one corresponding protection connection comprising a plurality of protection links;
identifying a lowest risk protection layer as a lowest of plurality of metal layers at which any of the risk links is established;
determining whether a connection is established for all of the protection links at the lowest risk protection layer; and
when it is determined that a connection is established for all of the protection links at the lowest risk protection layer, then returning a PASS result.

2. The method of claim 1, wherein identifying a lowest risk protection layer comprises identifying a lowest risk protection layer among each of the plurality of risk links by analyzing the plurality metal layers to determine whether connection is established for each of the risk links.

3. The method of claim 2, wherein the computer system only analyzes metal layers for each risk link that are below the metal layers of the plurality of metal layers in which a connection has already been established for one of the risk links.

4. The method of claim 2, wherein, if a connection is established for a risk link at a lowest one of the metal layers, then the lowest one of the metal layers is identified as the lowest risk protection layer and the computer system stops analyzing whether a connection is established for each of the risk links.

5. The method of claim 1, wherein determining whether a connection is established for all of the protection links at the lowest risk protection layer includes analyzing each of the protection links to determine whether a connection is established at the lowest risk protection layer, and not analyzing the protection links at any other metal layer.

6. The method of claim 1, further comprising, when it is determined that a connection is not established at every one of the protection links at the lowest risk protection layer, then returning a FAIL result.

7. The method of claim 1, wherein the computer system stops determining whether a connection is established for all of the protection links at the lowest risk protection layer when the computer system determines that a connection is not established for any one of the protection links at the lowest risk protection layer.

8. The method of claim 1, further comprising determining a PASS or FAIL of the PID group based on determining whether a connection is established for all of the protection links at the lowest risk protection layer.

9. The method of claim 1, further comprising modifying a circuit design layout based on determining that a connection is not established at every one of the protection links at the lowest risk protection layer.

10. A computer system comprising a processor and an accessible memory, the computer system particularly configured to:
receive a plasma induced damage (PID) group defining a plurality of metal layers and having at least one risk connection comprising a plurality of risk links, and at least one corresponding protection connection comprising a plurality of protection links;
identify a lowest risk protection layer as a lowest of plurality of metal layers at which any of the risk links is established;
determine whether a connection is established for all of the protection links at the lowest risk protection layer; and
when it is determined that a connection is established for all of the protection links at the lowest risk protection layer, then return a PASS result.

11. The computer system of claim 10, wherein identifying a lowest risk protection layer comprises identifying a lowest risk protection layer among each of the plurality of risk links by analyzing the plurality metal layers to determine whether connection is established for each of the risk links.

12. The computer system of claim 11, wherein the computer system only analyzes metal layers for each risk link that are below the metal layers of the plurality of metal layers in which a connection has already been established for one of the risk links.

13. The computer system of claim 11, wherein, if a connection is established for a risk link at a lowest one of the metal layers, then the lowest one of the metal layers is identified as the lowest risk protection layer and the computer system stops analyzing whether a connection is established for each of the risk links.

14. The computer system of claim 10, wherein determining whether a connection is established for all of the protection links at the lowest risk protection layer includes analyzing each of the protection links to determine whether a connection is established at the lowest risk protection layer, and not analyzing the protection links at any other metal layer.

15. The computer system of claim 10, further comprising, when it is determined that a connection is not established at every one of the protection links at the lowest risk protection layer, then returning a FAIL result.

16. The computer system of claim 10, wherein the computer system stops determining whether a connection is established for all of the protection links at the lowest risk protection layer when the computer system determines that a connection is not established for any one of the protection links at the lowest risk protection layer.

17. The computer system of claim 10, further comprising determining a PASS or FAIL of the PID group based on determining whether a connection is established for all of the protection links at the lowest risk protection layer.

18. The computer system of claim 10, further comprising modifying a circuit design layout based on determining that a connection is not established at every one of the protection links at the lowest risk protection layer.

19. A non-transitory computer-readable medium encoded with executable instructions that, when executed, cause one or more computer systems to:
receive a plasma induced damage (PID) group defining a plurality of metal layers and having at least one risk connection comprising a plurality of risk links, and at least one corresponding protection connection comprising a plurality of protection links;
identify a lowest risk protection layer as a lowest of plurality of metal layers at which any of the risk links is established;
determine whether a connection is established for all of the protection links at the lowest risk protection layer; and
when it is determined that a connection is established for all of the protection links at the lowest risk protection layer, then return a PASS result.

20. The computer system of claim 10, wherein:
identifying a lowest risk protection layer comprises identifying a lowest risk protection layer among each of the plurality of risk links by analyzing the plurality metal layers to determine whether connection is established for each of the risk links;
the system only analyzes metal layers for each risk link that are below the metal layers of the plurality of metal layers in which a connection has already been established for one of the risk links;
if a connection is established for a risk link at a lowest one of the metal layers, then the lowest one of the metal layers is identified as the lowest risk protection layer and the computer system stops analyzing whether a connection is established for each of the risk links; and
determining whether a connection is established for all of the protection links at the lowest risk protection layer includes analyzing each of the protection links to determine whether a connection is established at the lowest risk protection layer, and not analyzing the protection links at any other metal layer.
